(19) United States
(12) Patent Application Publication
(10) Pub. No.: US 2004/0059670 A1
(43) Pub. Date: Mar. 25, 2004

(54) Method for loan refinancing

(75) Inventor: Bradley M. Mills, Roanoke, IN (US)

Correspondence Address: FITCH EVEN TABIN AND FLANNERY, 120 SOUTH LA SALLE STREET, SUITE 1600, CHICAGO, IL, 60603-3406, US

(73) Assignee: Mortgage Gamma, LLC

(21) Appl. No.: 10/252,944

(22) Filed: Sep. 23, 2002

(51) Int. Cl. G06F 17/60

(52) U.S. Cl. 705/38

(57) ABSTRACT

A mortgage lender/broker obtains a deposit from a customer in proportion to the size of the customer's mortgage and delivers this deposit to a rate guarantor. The customer's deposit plus a bonus is returned if an agreed upon refinance rate in an agreed upon period of time cannot be obtained, or the customer's refinance rate is locked-in for him and the lender keeps the customer's deposit. Call spreads are sold in a financial instrument to sell off the optionality obtained by the rate guarantor and hedged such that profits will be level based on all possible market outcomes. When the price of the instrument stays the same or decreases and the call spreads are not exercised, the rate guarantor collects the premiums from these call spreads sold and returns to the customer his deposit in addition a bonus payout. When the price of the instruments increases, the call spreads are exercised against the rate guarantor and the rate guarantor keeps the customer's deposit to cover losses from the call spreads. The increase in the price of the instruments results in lowering of the mortgage rates and the lender/broker is able to lock-in the customer's agreed upon refinance rate.

### FIELD OF THE INVENTION

The present invention relates generally to loan financing and, more particularly, to methods for loan refinancing based on fluctuations in financial instruments.

### BACKGROUND OF THE INVENTION

The present economic situation has been marked by many significant events, resulting in volatile equity and bond markets and a general economic downturn. However, a surprising cornerstone even during this economic downturn continues to be the real estate market. Because of historically low interest rates created by the present economic situation, a particular aspect of the flourishing real estate market has been the sustained increase in loan refinancing for many different loans and particularly mortgage refinancing of existing home loans. Further, attractive refinance interest rates also have led to an increase in refinancing of cars, boats and other large items.

Much of the refinancing is originated by mortgage brokers, or loan brokers, acting to bring borrowers and lenders together for the purpose of loan origination. Such brokers typically charge a fee or a commission for their services. The ultimate lender, generally a bank or a savings and loan institution pays the loan broker his fee and then loans money to the borrower who agrees to pay back the money over a period of several years. The payback amount includes interest, typically a percentage of the loan amount, which the bank keeps for itself as profit on the loaned money.

For example, in most refinancing transactions, a customer works through either the bank or a loan broker to determine whether the customer is indeed a candidate to refinance his current home. Typically, either through advertising by a loan broker, bank or other mortgage financing company, a borrower learns or is made aware that interest rates have fallen. The borrower then contacts the bank to determine if he will realize any cost savings by refinancing his current mortgage. Generally, determining whether a customer receives any benefit from refinancing a current mortgage requires calculating whether the customer will own the property long enough to recapture the expense connected with the new loan.

A customer who has a mortgage that is at or near the currently available mortgage rates is typically not a good candidate to refinance his mortgage. The customer is able to refinance his mortgage if rates go down, but if rates stay the same or go up, the customer keeps his current mortgage. Therefore, the customer gains monetarily if mortgage rates go down, but does not gain when mortgage rates stay the same or go up.

A well known rule of thumb within the real estate industry is that generally a borrower may safely refinance when the new mortgage rate is at least one to two points lower than the existing loan rate, and that the borrower plans on staying in the home for at least three to five years. As a result, a typical borrower carrying his original loan may well have to wait an inordinately long time before, if ever, interest rates drop to a level low enough to justify refinancing the original loan.

### BRIEF DESCRIPTION OF THE DRAWINGS

FIG. 1 is a flow diagram of the loan refinancing method in accordance with the invention;

FIG. 2 is a graphical diagram depicting an exemplary first month profit profile in accordance with the invention; and

FIG. 3 is a graphical diagram depicting an exemplary second month profit profile in accordance with the invention.

### DETAILED DESCRIPTION

The invention relates to obtaining the optionality as to whether a customer refinances his mortgage and selling that optionality as a commoditized spread option in the futures markets. The profit from selling the optionality is shared with the customer, the rate guarantor, and the mortgage lender/broker.

In the United States of America, mortgage rates have a very high correlation to the interest rate on the 10 Year Treasury Note Futures. The interest rate on the 10 Year Treasury Note Futures is inversely proportional to the price of these same 10 Year Treasury Note Futures. Thus, mortgage rates are inversely proportional to the price of the 10 Year Treasury Note Futures. Hence, the customer gains monetarily with an increase in the price of the 10 Year Treasury Note Futures, but he neither gains nor loses when the price of the 10 Year Treasury Note Futures stays the same or decreases. In terms of options, the customer is theoretically long calls on these 10 Year Treasury Note Futures. These calls are then sold for the customer, giving a large portion of the benefits back to the customer.

It is to be noted that other countries similarly have financial instruments that correlate highly with those countries' respective mortgage rates, as shown by way of example only in Table 1 below. Accordingly, the present method may be used in many different countries, other than those shown and described herein, having financial instruments closely related to mortgage rates.

TABLE 1

| Country | Underlying Commodity as Hedge | Exchange |
|---|---|---|
| Australia | Australian 10 Year 6% Bond Future | Sydney |
| Austria | Euro-Bond Future | Frankfurt |
| Belgium | Euro-Bond Future | Frankfurt |
| Canada | Canada 10 Year Bond Future | Montreal |
| Denmark | Danish 6% Bond Futures | Copenhagen |
| Finland | Euro-Bond Future | Frankfurt |
| France | Euro-Bond Future | Frankfurt |
| Germany | Euro-Bond Future | Frankfurt |
| Greece | Euro-Bond Future | Frankfurt |
| Ireland | Euro-Bond Future | Frankfurt |
| Italy | Euro-Bond Future | Frankfurt |
| Japan | Japanese 10 Year Bond Future | Tokyo |
| Luxembourg | Euro-Bond Future | Frankfurt |
| Netherlands | Euro-Bond Future | Frankfurt |
| Portugal | Euro-Bond Future | Frankfurt |
| Spain | Euro-Bond Future | Frankfurt |
| Sweden | Swedish Notional 5 Year Mortgage | Stockholm |
| | Future | |
| Switzerland | Swiss Fed Bond Future | Zurich |
| United Kingdom | Long Gilt Future | London |
| United States | 10 Year Treasury Note Future | CBOT |

The above and other advantages are realized by a mortgage broker obtaining a deposit from the customer in proportion to the size of his mortgage. An agreement is made with a rate guarantor (RG) whereby the customer's deposit with a 25% bonus is returned if an agreed upon refinance rate in an agreed upon period of time cannot be obtained, or the customer's refinance rate is locked-in for him and the RG keeps the customer's deposit. Call spreads are then sold in the 10 Year Treasury Note Futures to sell off the optionality obtained by the RG and hedged such that profits will be level based on all possible market outcomes. When the price of the 10 Year Treasury Note Futures stay the same or decreases and the call spreads are not exercised, the RG collects the premiums from these call spreads sold and returns to the customer his deposit in addition to a bonus payout. When the price of the 10 Year Treasury Note Futures increases, the call spreads are exercised against the RG and the RG keeps the customer's deposit to cover losses from the call spreads. Because the price of the 10 Year Treasury Note Futures increases, the mortgage rates come down, and the mortgage broker is able to lock-in the customer's agreed upon refinance rate. A particular advantage of the present loan refinancing program is that the RG is able to generate equal profits for all market outcomes based on hedging his risk properly. Note, that as mentioned above, the 10 year Treasury Note Future is by way of example only. RGs in other countries are able to use the methods herein using other securities to achieve substantially the same results.

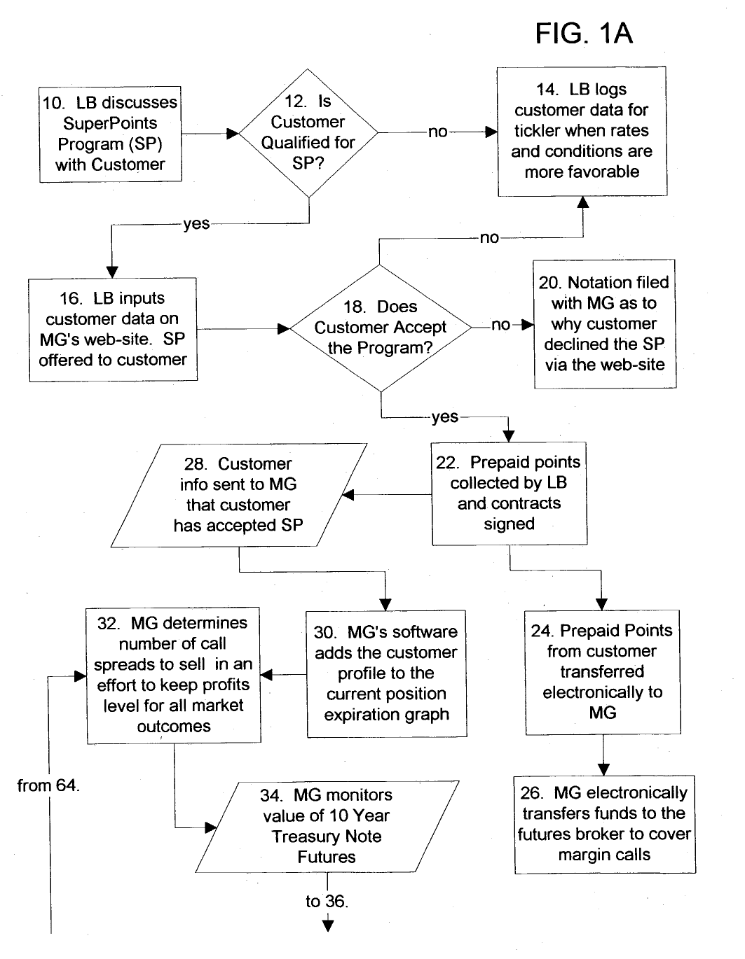

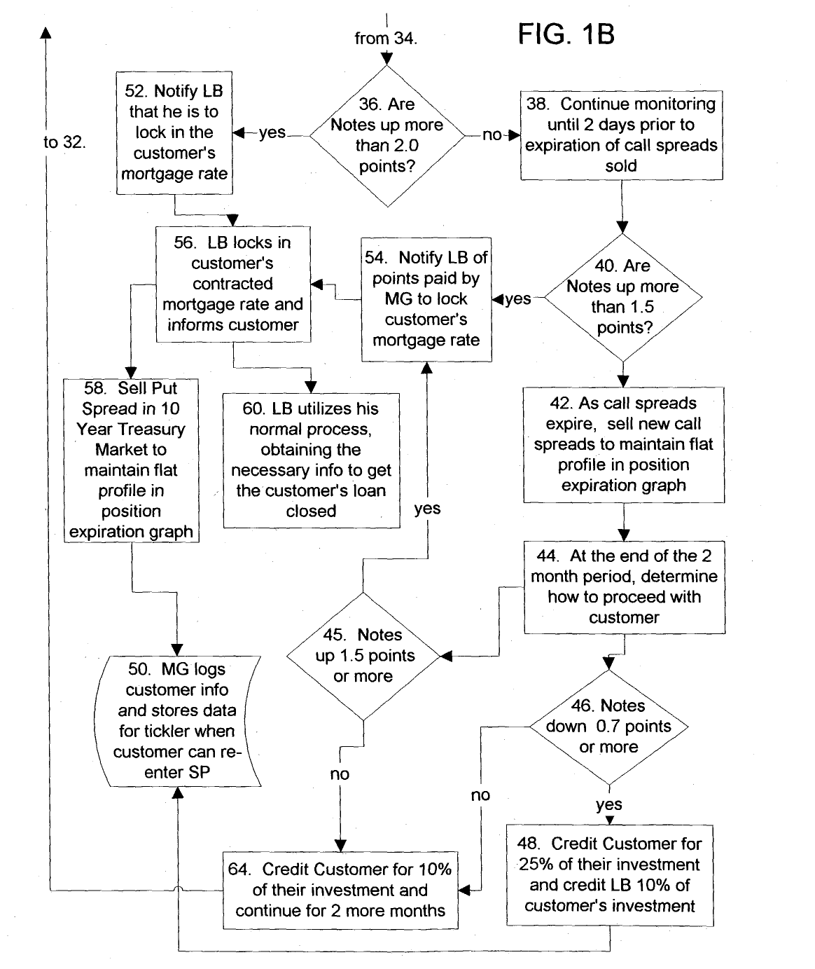

Referring to FIG. 1, the loan refinancing method is shown in operation. In step 10, the loan broker (LB) discusses the refinancing program with a potential customer. The LB offers the program to any existing, potential, or former customer. Once a customer is acquired, the loan broker discusses the loan program with the customer in detail. It is to be noted that that the loan broker is only one medium by which the customer is notified of the refinancing program. Various other channels of advertising, including the internet, television and radio also maybe used to advertise the program to potential customers.

In step 12, it is determined whether the customer is qualified for the refinancing program. If the customer is interested in the refinancing program, the LB asks the necessary questions in good faith of the customer to determine whether the customer is a candidate to refinance his current mortgage. Ideally, the customer has a near perfect credit rating, a minimum of 10% equity in their home, plans to stay in his current home for three or more years, and has an interest rate on his current mortgage that is very close to the triple zero refinance rate available in the market at the time. “Triple Zero” refers to when a customer refinances his mortgage and pays no points, origination fee, or any other closing costs with the exception of prepaid items such as escrows for taxes and insurance as well as prepaid interest to the end of the current month.

If the LB determines that the customer is not qualified currently for the refinancing program, then in step 14 the LB logs the customer's data in a tickler file or electronic reminder database system for notification of when rates and conditions are more favorable to providing the unqualified customer the loan refinancing product. Thus, if the situation changes in the customer's favor, the system will remind the LB to re-approach the customer. For example, if the customer's current interest rate is below current triple zero rates, then the LB monitors interest rates until the program is possibly attractive to the customer and contacts the customer at that time. However, if the customer is not interested in the program or declines an invitation to join, the customer is not re-approached.

In step 16, after the customer has been qualified by the LB, the LB inputs the customer's data into the RG's website. Once the LB determines the customer is a potential candidate for the refinancing program, he sends the customer's data to the RG, including the change in the 10 Year Treasury Note Futures needed for the LB to give the customer a ¼ point reduction from his current mortgage rate. The RG then calculates and returns the precise offer back to the LB for presentation to the customer.

For example, the customer's mortgage rate maybe equal to 6.50% and have a term of 30 years with a mortgage balance of $300,000.00. Further, the current available 30-year mortgage rate for a triple zero mortgage is 6.50% and the current 10-year treasury-note future is 105 26/32. Thus, with the ¼ point reduction, the new mortgage rate offer to the borrowers is 6.25% with a term of 30 years. The fee required is $2250, which is equal to 0.75% of the new mortgage amount. The customer's savings in interest rate payments at the new rate over a period of three years will be $2255.00. Advantageously, the customer does not have to wait for the one- to two-point drop in interest rate and/or recoup his refinancing fee within a period of four or more years, but recoups his refinancing fee within a period of three years. As shown above, significantly the customer's current interest rate and the market rate are identical and yet with the present refinancing method, the borrower is provided a quarter point reduction over his existing loan rate.

The customer, having been presented the above offer by the LB, may choose to decline or accept the offer in step 18. As the offer is predicated on the current rate of the 10 Year Treasury Note Futures, the customer must make a decision to accept or decline the offer within a short period of time (i.e. less than 10 minutes). The specific loan program offering possibly may be rescinded because of market movements before the loan program is locked in and has been confirmed with the RG. As soon as practicable, the RG confirms that the loan program terms have been locked in for the customer. When the RG sends the confirmation to the LB, the loan program lock is in place and all parties are bound by the specific deal at that time.

If, however, the customer declines the loan offer, then a notation is filed with the RG in step 20 as to why the customer refused to participate in the loan program. This may be done through the RG's web site for convenience. The RG collects and stores this information. Further, the RG monitors this information to determine if a situation has changed making the program more attractive to the customer. If such an event occurs, a notice is sent to the LB and the customer suggesting to both parties that the loan program be re-addressed. If the customer simply was “not interested” in the program, the customer is not re-approached.

In step 22, the LB collects the prepaid points and obtains the proper signature(s) from the customer. The customer pre-signs the rate-lock form so that when it is possible to lock in the new mortgage rate, the LB does not need to obtain customer approval at that time in the future. The LB also signs the contract as the provider of the interest rate reduction if the bonds move up as specified in the contract. Preferably, all customer paperwork is filed and stored by the LB. The prepaid points received by the LB from the customer are transferred electronically to the RG. For example, the LB has two (2) working days to electronically transfer the prepaid points to the RG. Funds delivered after the two working days are subject to late fees and/or interest.

In step 26, the RG electronically transfers the funds received from the LB to a futures broker to cover margin calls. The margin requirement in the brokerage account typically fluctuates on a daily basis due to market movements, new customers, and customers concluding the program. The RG preferably monitors the margin requirement on a daily basis (or more often) to maintain sufficient margin with the brokerage firm.

Once the prepaid points have been collected and agreements signed, the customer's information is sent to the RG indicating that the customer has accepted the loan program. The RG then logs the information in a database relating to the specific loan program offer accepted by the customer.

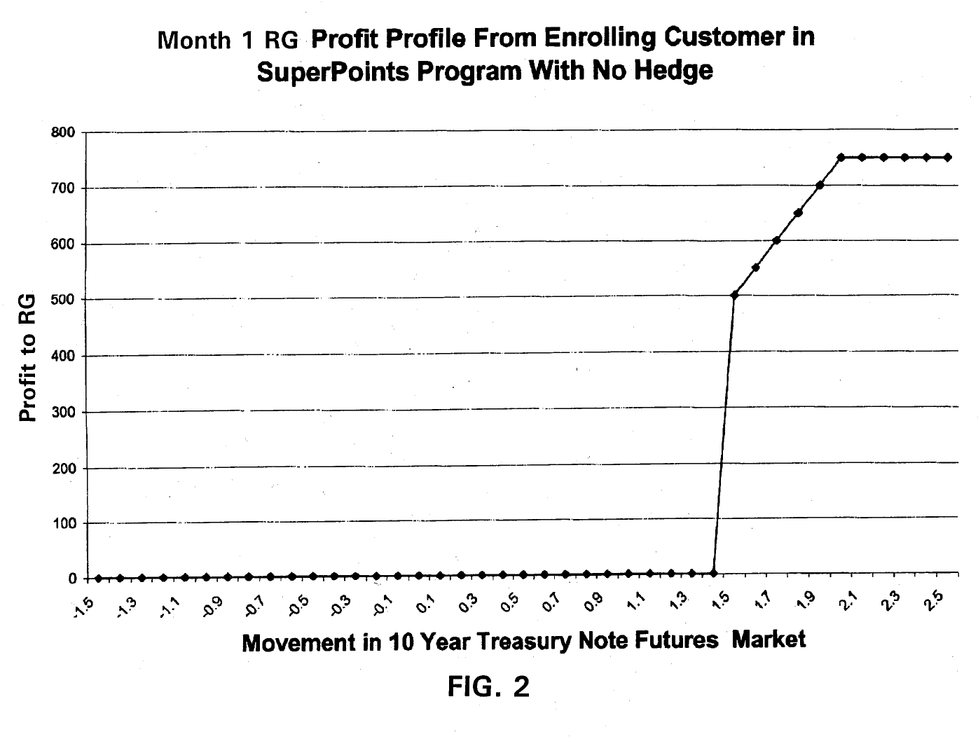

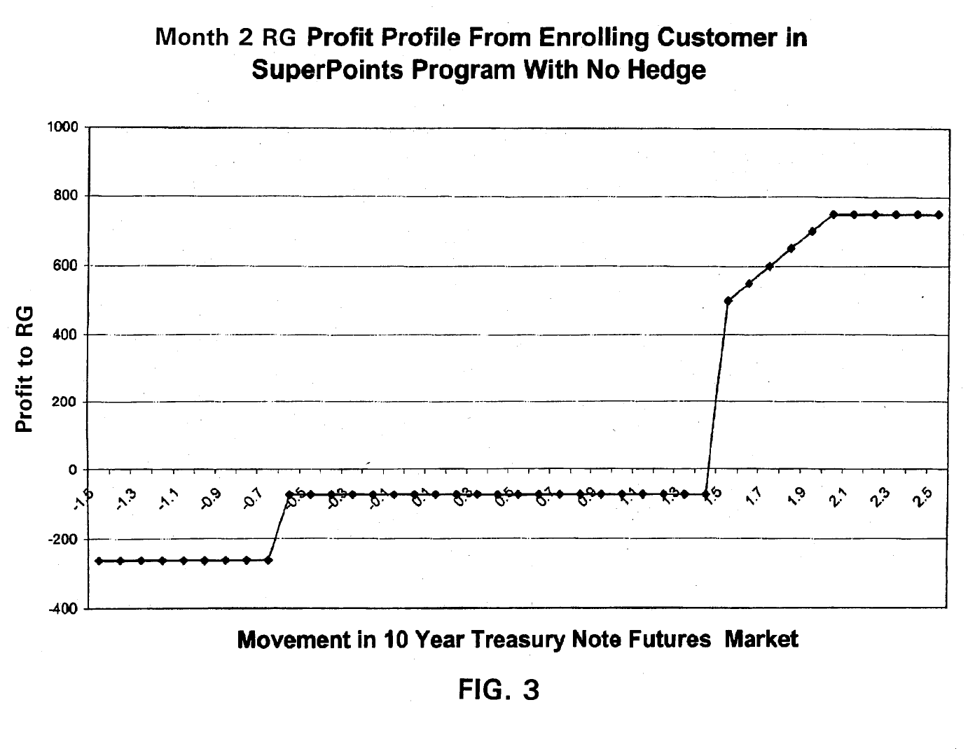

The RG's software adds the customer profile to the current position expiration graph in step 30. In particular, acquiring a customer makes the RG inherently long certain call spreads in the 10 Year Treasury Note Futures. For example, for each $100,000 of customer mortgage with a three (3) year payback, the RG is long one at-the-money-plus-one to at-the-money-plus-two (ATM+1/ATM+2) call spread. This expiration graph profile from the new customer is added to the RG's overall expiration graph position. The initial month expiration graph profile and the second month expiration graph profile for the example given above is shown in FIGS. 2 and 3, respectively.

In step 32, the RG determines the number of call spreads that need to be sold to keep profits level for all market outcomes. As the 10 Year Treasury Note Futures move and customers enter and leave the program, the RG's overall expiration graph position changes dramatically from day to day. The RG therefore attempts to keep the profit shown on the expiration graph profile as level as possible for all ranges of the 10 Year Treasury Note Futures. For example, the value of the 107/108 Call Spread equals 16/64 pt. Accordingly, the number of call spreads to be sold equals 3. The number of days before prompt month options expire equals 30 days. Thus, the initial month premium received (net of any LB fees) is $700.

The RG monitors the value of 10 Year Treasury Note Futures since the specifics of the loan program offer to the customer is directly linked to the current value of the 10 Year Treasury Note Futures. Additionally, the market values at which the customer exits the program via either of the options is largely dependent on these 10 Year Treasury Note Futures. Thus, in step 34 the RG closely monitors the bond market to determine if any customer's rate can be locked in or if any customer can be given a 25% bonus for exiting the program (as described below).

In step 36, it is determined whether at any time the 10 Year Treasury Note Futures are up 2.0 points or more from where the customer entered the program. If so, the mortgage market is at a point where the customer receives his rate-lock ¼ point lower than his existing mortgage. The change in the treasury note futures is monitored throughout the two-month period of customer involvement so that any time the notes are at this level at the time rates are made by the mortgage brokers, the customer's rate is locked in. If, for example, the 10 Year Treasury Note Futures rise rapidly in first month, then the call spreads get exercised away resulting in a loss in market of $3000. However, the RG is still able to profit in this case. The initial month premium received is $700, the net premium from selling the 108/107 put spread is $650 and the RG's fee from the customer is $2250. This results in the RG realizing a net profit of $600.00

Upon determining that the 10 year Treasury Note Futures have increased the required number of points, the RG in step 52 notifies the LB that he is to lock in the customer's rate. Preferably, the RG sends notice electronically to the LB notifying him that he is to lock in the customer's previously agreed upon mortgage rate. The RG also may send a notice to the respective customer that his LB should be contacting him soon. At this point, in step 56, the LB locks in customer's contracted mortgage rate as specified in the original customer contract and informs the customer of the rate-lock using email, postal service, telephone, facsimile, or any other method. Electronic means of notification generally is preferred so as to decrease the cost associated with handling paper documents.

In step 60, the customer's involvement with the loan process is complete. The LB utilizes his normal process for obtaining the necessary info to get the customer's loan closed. The LB collects the information necessary to send the items to the title company to close the customer's loan. The points paid by the customer for this loan program may be indicated on the closing documents as “points” paid by the customer.

When the customer receives his rate-lock, the RG keeps the points paid by the customer. The RG in step 58 then sells identical put spreads to the latest call spreads sold for each customer receiving a rate lock. This locks in the profit to the RG such that the profit to the RG is the same for this customer regardless of the direction in which the bonds move. This is because once call spreads and the identical put spread are sold, the profit or loss from these instruments is fixed in regard to any market movement. The RG may alternatively decide to buy back the shorted call spreads, accomplishing the same financial outcome as selling the matching put spreads. Thus, as mentioned above, if the 10 Year Treasury Note Futures rise rapidly in first month, the net premium from selling the 108/107 put spread is $650. Thus, even with a market loss of $3,000.00, the RG makes a profit. This is true because the RG receives the initial month premium of $700.00, a net premium of $650.00 from selling 108/107 put spread and the fee from the customer of $2250.00. Thus, the RG is able to operate a net profit of $600.00.

In step 50, the RG logs the customer's info and stores data for tickler when the customer can re-enter the loan program. Advantageously, although this customer has just refinanced, he remains a potential candidate for a further refinance if mortgage rates move down again. Therefore, the RG logs this customer's new mortgage data such that once the customer closes their new loan, he may be instantly eligible to re-enter the SP. The RG, on an on-going basis, monitors its databases to determine if the loan program may again be attractive to the customer. If such an event occurs, a notice is sent to the LB and the customer suggesting the loan program be entered into again.

If it was determined in step 36 that the notes are not up by more than 2 points, then the RG in step 38 continues monitoring the notes until 2 days prior to expiration of call spreads sold. The 10 Year Treasury Note Futures are monitored to determine if the customer should be locked in. Any time the 10 Year Treasury Note Futures are up more than 2.0 points, the customer will have his rate locked-in. However, two days prior to expiration of the call spreads sold, a different set of circumstances apply. In particular, in step 40 it is determined whether the notes are up by more than 1.5 points, but less than 2.0 points during the last two days before the expiration of the options. If so, the customer's contracted ¼ point mortgage rate cut is locked in. The RG pays the LB an amount necessary to “buy-down” the mortgage rate for the customer, allowing the LB to make the same amount of money on this refinanced mortgage. The RG pays the LB the amount of 0.05% of the customer loan amount per 0.1 point that the 10 Year Treasury Note Futures are below the normal 2.0 point increase needed to lock-in the customer rate.

For example, if the 10 Year Treasury Note Futures are up 1.7 points two days prior to the first option expiration, then the net premium from selling the 108/107 put spread is $1600. The net loss from the 107/108 put and call spreads is $3000. The payment to the LB to lock-in the customer rate is $700.

Because of the deposit of $2250.00 paid by the borrower, the RG realizes a net profit of $850.00. Even in this scenario the RG is able to realize a profit since the net premium from selling the 108/107 put spread is $1600 and the fee paid by the borrower is $2250, resulting in a profit to the RG of $850.

If the note rate is up by less than 2.0 points, but more than 1.5 points, the RG sends a notice to the LB in step 54 notifying him that he is to lock in the customer's previously agreed upon mortgage rate. The RG also notifies the LB the amount he will be paid to buy-down the customer's rate. The RG also sends a courtesy notice to the customer notifying him that his LB will be contacting him.

Assuming the customer has not been closed via a rate-lock in step 56, as shorted call spreads expire, another set of call spreads is sold for the next prompt month. Because the value to the RG is different in the second month than as the first, the RG sells a different set of call spreads in the second month. The RG keeps the hedging for the second month as close to 0.865 of the ATM+1/ATM+2 call spreads and 0.25 of the ATM-1/ATM call spreads for each $100,000 of customer mortgage in the program. This procedure is continued until the two-month deal with the customer expires.

By way of a first example, if the 10 year treasury note futures are down 0.5 Points after the first option expiration, then the net from the first month (premium from first month) is $650. In the second month, the premium from selling one 105/106 call spread is $450 and the premium from selling two 107/108 call spreads is $375. In a second example, if the 10 year treasury note futures are up by 0.5 points after the first option expiration, then the net from the first month premium is $650 and the second month premium from selling one 105/106 call spread is $600 and the premium from selling two 107/108 call spreads is $900.

At the end of the 2-month period, it is determined in step 44 how to proceed with customer. At this point, the customer gets his refinance rate locked-in, receives his money back and a 25% of the loan points bonus for exiting the program, or receives a 10% (of the loan paid) bonus for staying in the program for an additional two months. The decision is based on whether the notes are up 1.5 points or more or down 0.7 points or more from where the customer entered the program.

If in step 45 it is determined that the 10 Year Treasury Note Futures are up more than 1.5 points at the expiration of the 2-month period for the customer, the customer's new mortgage rate is locked in. The RG pays the LB an amount necessary to “buy-down” the mortgage rate for the customer, allowing the LB to make the same amount of money on this refinanced mortgage. The RG pays the LB an amount of 0.05% of customer loan amount per 0.1 point that the 10 Year Treasury Note Futures are below the normal 2.0 point increase needed to lock-in the customer rate. The RG then either buys-back the call spreads associated with this customer's deal or applies them to a new customer that comes into the program.

However, the RG is still able to realize a profit because of the $650 from the first month premium, the premium from selling one 105/106 call spread of $450.00, the premium from selling two 107/108 call spread at $375 and the retained $2250.00 fee from the borrower. This results in a net profit to the RG of $1665.00.

Thus, in a first scenario where the 10 Year Treasury Note Futures are down 0.5 points after the first option expiration and up 1.5 points after the second option expiration, the RG is able to realize a net profit of $1665. In this case, the RG receives a net premium from the first month of $650, a premium from selling one 105/106 call spread of $450, a premium from selling two 107/108 call spreads of $375 and the $2250 fee from the customer. Thus, even with a loss in the market of $1000 from the 105/106 call spread being exercised and the $2000 loss from the 107/108 put and call spread, the RG is able to profit.

In a second scenario, where the 10 Year Treasury Note Futures are up 0.5 points after the first option expiration and up 1.5 points after the second option expiration, the RG realizes a profit of $2340. Here, the RG receives a net premium from the first month of $650, a premium from selling one 105/106 call spread of $600, a premium from selling two 107/108 call spreads of $900 and the $2250 fee from the customer. The RG profits even with a loss in the market of $1000 from the 105/106 call spread being exercised and the $2000 loss from the 107/108 put and call spreads. Therefore, as can be seen, the RG is able to profit in both the above exemplary scenarios, notwithstanding the market conditions.

If it is determined in step 46 and step 45 that at the end of the two-month customer period the 10 Year Treasury Note Futures are down less than 0.7 points or up less than 1.5 points from the original deal with the customer, the customer continues in the program for another two months in step 44. Further, the customer is credited a 10% (of the points paid) bonus by the RG for remaining in the program for this additional two months. The process then returns to the RG proceeding from step 32.

Thus, in the scenario where the 10 Year Treasury Note Futures are down 0.5 points after the first option expiration and up 0.5 points after the second option expiration, the RG is able to realize a net profit of $250 and continue to retain the customer in the program. In this case, the RG receives a net premium from the first month of $650, a premium from selling one 105/106 call spread of $450, a premium from selling two 107/108 call spreads of $375 and the $2250 fee from the customer. Thus, even with a loss in the market of $1000 from the 105/106 call spread being exercised and paying the customer 10% of the loan fee, which is $225, the RG is able to profit.

In an alternate scenario, where the 10 Year Treasury Note Futures are up 0.5 points after the first and second option expirations the RG still realizes a profit of $925. The RG receives a net premium from the first month of $650, a premium from selling one 105/106 call spread of $600, a premium from selling two 107/108 call spreads of $900 and the $2250 fee from the customer. The RG profits even with a loss in the market of $1000 from the 105/106 call spread being exercised and paying the customer 10% of the loan fee, which is $225. Thus, the RG profits in both scenarios, again, notwithstanding the market movement.

However, if at the end of the 2-month customer period the 10 Year Treasury Note Futures are down more than 0.7 points from the original deal with the customer, then in step 60 the customer receives his money back plus a 25% (of the points paid) bonus for exiting the program. The RG also credits the LB a 10% (of the points paid) commission for his participation in the program. Even in this scenario, the RG is able to generate a profit.

In a first example, where the 10 Year Treasury Note Futures are down 0.5 points after the first option expiration and down 1.1 points after the second option expiration, the RG is able to realize a profit. In this case, the RG receives a net premium from the first month of $650, a premium from selling one 105/106 call spread of $450 and a premium from selling two 107/108 call spreads of $375. Even having to pay the customer the 25% bonus and the LB the 10% bonus, the RG realizes a profit of $687.

In a second example, where the 10 Year Treasury Note Futures are down 0.5 points after the first option expiration and down 1.1 points after the second option expiration, the RG still realizes a profit of $1362. In particular, the RG receives a net premium from the first month of $650, a premium from selling one 105/106 call spread of $600, and a premium from selling two 107/108 call spreads of $900. Even paying the customer the 25% bonus and the LB the 10% bonus, the RG profits.

Thus, it can be seen that in almost all possible scenarios, the RG, the LB and the customer are able to realize financial gains from the loan refinancing method as shown and described.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A method for refinancing a loans comprising the steps of:
determining whether a loan holder carrying an existing loan at a predetermined rate fits a predetermined eligibility profile;
collecting a fee for providing a predetermined rate reduction relative to the held loan rate;
investing the collected fees in one or more financial instruments; and
realizing a profit from negotiation of the financial instruments based on volatility of financial market conditions.

2. The method of claim 1, wherein profit by a rate guarantor is realized regardless of the market movement of mortgage rates.

3. The method of claim 1, wherein the loan holder realizes a financial gain when mortgage rates move higher.

4. The method of claim 3, wherein the collected fees are invested in securities related to the market movement of mortgage rates.

5. The method of claim 4, wherein the invested securities comprise call spreads.

6. The method of claim 5, wherein the call spreads are purchased in 10 Year Treasury Note futures.

7. The method of claim 5 further comprising the step of retaining the customer's deposit to cover losses from the sale of the call spreads.

8. The method of claim 5 further comprising the step of returning the customer's deposit to the customer.

9. The method of claim 5, wherein the customers deposit is returned along with an additional amount as a bonus for the customer to discontinue the loan refinancing.

10. The method of claim 1, further comprising the step of compensating a party that caused the customer to join the refinancing program.

11. A loan refinancing method comprising the steps of:
obtaining a deposit from a customer in proportion to the size of the customer's outstanding mortgage;
purchasing one or more financial instruments using the deposit;
monitoring interest rates for a predetermined period of time; and
returning the customer's deposit with a predetermined bonus if an agreed upon refinance rate in the predetermined period of time cannot be obtained.

12. The loan refinancing method of claim 11, wherein the purchased financial instruments comprise call spreads in financial instruments related to mortgage rates.

13. The loan refinancing method of claim 12, further comprising the steps of:
determining whether the price of the financial instruments has decreased; and
selling the call spreads and collecting the premiums from the sold call spreads.

14. A loan refinancing method comprising the steps of:
obtaining a deposit from a customer in proportion to the size of the customer's outstanding mortgage;
purchasing one or more financial instruments using the deposit;
monitoring interest rates for a predetermined period of time;
retaining the customer's deposit if an agreed upon refinance rate in the predetermined period of time is obtained.

15. The loan refinancing method of claim 14, wherein the purchasing step further comprises the step of purchasing call spreads in financial instruments that change in value as mortgage rates change.

16. The loan refinancing method of claim 14, further comprising the steps of:
determining whether the price of the financial instruments has increased; and
locking in the mortgage rate at an agreed upon rate.
